(19) United States
(12) Patent Application Publication
(10) Pub. No.: US 2024/0262083 A1
(43) Pub. Date: Aug. 8, 2024

(54) FOLDABLE TRANSPARENT COMPOSITE FILM AND METHOD OF MANUFACTURING THE SAME

(71) Applicant: SOLIP TECH CO., LTD., Daejeon (KR)

(72) Inventor: Ji Hoon KO, Daejeon (KR)

(21) Appl. No.: 18/423,546

(22) Filed: Jan. 26, 2024

(30) Foreign Application Priority Data
Feb. 3, 2023 (KR) 10-2023-0014739

(51) Int. Cl. B32B 17/10; B32B 7/12; B32B 27/08

(52) U.S. Cl. CPC B32B 17/10; B32B 7/12; B32B 27/08; B32B 2307/412; B32B 2307/418

(57) ABSTRACT

One embodiment provides a cover window for a foldable display including a non-folding part of a plastic film cover window, which has improved pen-drop impact resistance, and at the same time, a folding part with excellent foldability, a method of manufacturing the same, and a display device including the same. According to one embodiment, since, by being used as a protective film of an ultra-thin glass used as the cover window for a foldable display, a non-folding part of the ultra-thin glass can have the impact resistance reinforced with a plastic film and a glass-fabric reinforced plastic film and reduce a degradation in the foldability of a folding part due to the use of the protective film, it is possible to improve pen-drop impact resistance of the non-folding part of the ultra-thin glass and at the same time, implement the folding part with the excellent foldability.

### CROSS REFERENCE TO RELATED APPLICATION

The present application claims priority to Korean Patent Application No. 10-2023-0014739, filed on Feb. 3, 2023, the entire contents of which are incorporated herein for all purposes by this reference.

### BACKGROUND OF THE INVENTION

### Field of the Invention

The present invention relates to a foldable transparent composite film and a method of manufacturing the same, and more specifically, to a foldable transparent composite film, which can improve folding performance of a flexible area and increase a strength, hardness, and impact resistance of a reinforced area by dividing an area into the reinforced area and the flexible area on a plastic film and bonding a transparent glass-fabric reinforced plastic film to the reinforced area, and a method of manufacturing the same.

### Description of the Related Art

The focus is on the convenient mobility of information terminals such as smartphones, tablet PCs, and laptops, and technologies for miniaturization and weight reduction of the terminals are being actively researched, but at the same time, since a display for conveying information through the information terminals requires a larger size as the amount of information increases, technology development for this is also being actively conducted.

In order to satisfy both of these conflicting demands, a flexible display technology capable of folding, bending, rolling, or sliding is in the spotlight as the next-generation technology to have advantages of convenient portability and a larger screen. Among them, since foldable displays have advantages of being portable in a folded state and capable of implementing a large screen display in an unfolded state, the foldable displays are applied to various display applications such as smartphones, tablet PCs, navigation devices, e-books, and laptops.

The foldable display commonly requires a cover window for protecting the inside of the display and allowing the user to touch the display at an outer side thereof. Cover windows for a rigid display according to the related art have mainly used glass which is transparent and has high strength and hardness. However, the cover window for a foldable display should secure flexibility to be folded or bended, there should be no marks due to repeated folding or bending, and there should be no distortion accordingly, and since the glass may be easily broken upon folding or bending, there is a problem in that it is difficult to apply the glass to the foldable display.

In order to solve this problem, the cover window for a foldable display uses a plastic film such as transparent polyimide (CPI) or PET film on a display panel surface. However, there is a problem in that the plastic film has a low mechanical strength and surface hardness, leave marks on folded and bent parts, and may be broken by repeated folding and bending. Therefore, there is a need for the development of a transparent plastic film with a high strength and elastic modulus.

Conventionally, a transparent glass-fabric reinforced plastic film manufactured by impregnating a glass-fabric with siloxane resin with the same refractive index has been provided as a flexible display substrate film with heat resistance and a low coefficient of thermal expansion. The transparent glass-fabric reinforced plastic film has a high strength and elastic modulus and thus can also be applied as a cover window film. However, there is a limit to the folding of the transparent glass-fabric reinforced plastic film due to the breakage of the glass-fabric that is present in the film.

In addition, when the glass is reduced to an ultra-thin thickness of 0.1 mm or less, the glass may be folded or bent and used as the cover window for a foldable display. The related art has proposed a thin foldable glass cover window that may be folded or bent with low curvature. The ultra-thin glass (UTG) cover window is required to have basic physical properties that there should be no distortion of a display screen upon folding or bending and a sufficient strength to withstand external pressure and impact such as repeated contact with a touch pen should be secured. In order for the glass to be folded or bent, the glass should have a predetermined thickness or less, while in order to increase a strength, the glass should have the predetermined thickness or more. In order to mutually complement this, a glass cover window that satisfies both strength and folding characteristics by dividing an area into a folded area with a small thickness and the remaining areas with large thicknesses has been proposed.

The foldable or bendable UTG cover window may be easily broken by an external impact, and thus are used by attaching a protective plastic film for reinforcing impact resistance. When the plastic film used has a large thickness or high elastic modulus, the impact resistance of the UTG is improved. Therefore, conventionally, the UTG cover window with improved impact resistance by attaching the transparent glass-fabric reinforced plastic film with the high strength and elastic modulus instead of the plastic film has been proposed.

However, when the thickness of the protective plastic film used to improve the impact resistance of the UTG is increased or the plastic film with the high strength and elastic modulus is used, there is a problem that the foldability of the cover window is degraded, and thus a need for solving the above problem has emerged.

### DOCUMENTS OF RELATED ART

(Patent Document 1) Korean Patent No. 10-2147297

### SUMMARY OF THE INVENTION

The present invention is directed to solving the above problems of the related art and is directed to providing a foldable transparent composite film, which can improve folding performance of a flexible area and increase a strength, hardness, and impact resistance of a reinforced area by dividing an area into the reinforced area and the flexible area on a plastic film and bonding a transparent glass-fabric reinforced plastic (GFRP) film to the reinforced area, and a method of manufacturing the same.

The objects of the present invention are not limited to the above-described object, and other objects that are not mentioned will be able to be clearly understood by those skilled in the art to which the present invention pertains from the following description.

In order to achieve the object, one embodiment of the present invention provides a foldable transparent composite film.

The foldable transparent composite film (100) according to one embodiment of the present invention includes a folding part (1000) and a non-folding part (2000) adjacent to the folding part (1000), wherein the non-folding part (2000) includes a transparent glass-fabric reinforced plastic film layer (120).

In addition, according to one embodiment of the present invention, the folding part (1000) may include a plastic film layer (110), and a plastic resin layer (130) positioned on one or more among above and under the plastic film layer (110).

In addition, according to one embodiment of the present invention, the non-folding part (2000) may include a plastic film layer (110) and a plastic resin layer (130) positioned on one or more among above and under the plastic film layer (110), wherein the transparent glass-fabric reinforced plastic film layer (120) may be buried in the plastic resin layer (130).

In addition, according to one embodiment of the present invention, the plastic film layer (110) may include one selected from the group consisting of transparent polyimide (CPI), polyethylene terephthalate (PET), polyethylene naphthalate (PEN), polycarbonate (PC), acrylic, silicone, triacetyl cellulose (TAC), and combinations thereof.

In addition, according to one embodiment of the present invention, the transparent glass-fabric reinforced plastic film layer (120) may include a transparent plastic base and a glass-fabric buried in the transparent plastic base and a difference in refractive indexes between the transparent plastic and the glass-fabric may be 0.05 or less.

In addition, according to one embodiment of the present invention, the transparent plastic base may include one selected from the group consisting of acrylic-based resin, epoxy-based resin, silicone-based resin, siloxane-based resin, styrene-based resin, styrene acrylonitrile-based resin, polycarbonate-based resin, polyester-based resin, polyurethane-based resin, acrylonitrile butadiene styrene-based resin, and combinations thereof.

In order to achieve the object, another embodiment of the present invention provides an ultra-thin glass (200) to which a foldable transparent composite film is bonded.

The ultra-thin glass (200) to which the foldable transparent composite film according to one embodiment of the present invention is bonded may further include an ultra-thin glass layer (210) above the plastic resin layer (130) in the foldable transparent composite film (100).

In order to achieve the object, still another embodiment of the present invention provides a foldable display device.

In addition, according to one embodiment of the present invention, the above-described foldable transparent composite film may be used as a cover window or cover window protective film in the foldable display device.

In order to achieve the object, yet another embodiment of the present invention provides a method of manufacturing a foldable transparent composite film.

A method of manufacturing the foldable transparent composite film according to one embodiment of the present invention includes forming the plastic resin layer (130) on all of the folding part (1000) and the non-folding part (2000) adjacent to the folding part (1000) on the plastic film layer (110), wherein the transparent glass-fabric reinforced plastic film layer (120) may be buried in the non-folding part (2000) of the formed plastic resin layer (130).

In addition, according to one embodiment of the present invention, the forming of the plastic resin layer (130) may include forming a glass-fabric layer in the non-folding part (2000) with an empty folding part on one or more among above and under the plastic film layer (110), and entirely coating plastic resin on the plastic film layer (110) in the folding part (1000) and the glass-fabric layer in the non-folding part (2000), and performing pressing and curing.

In addition, according to one embodiment of the present invention, the plastic film layer (110) may include one selected from the group consisting of transparent polyimide (CPI), polyethylene terephthalate (PET), polyethylene naphthalate (PEN), polycarbonate (PC), acrylic, silicone, triacetyl cellulose (TAC), and combinations thereof.

In addition, according to one embodiment of the present invention, the transparent glass-fabric reinforced plastic film layer (120) may include a transparent plastic base and a glass-fabric buried in the transparent plastic base, wherein a difference in refractive indexes between the transparent plastic and the glass-fabric may be 0.05 or less.

In addition, according to one embodiment of the present invention, the transparent plastic base may include one selected from the group consisting of acrylic-based resin, epoxy-based resin, silicone-based resin, siloxane-based resin, styrene-based resin, styrene acrylonitrile-based resin, polycarbonate-based resin, polyester-based resin, polyurethane-based resin, acrylonitrile butadiene styrene-based resin, and combinations thereof.

In order to achieve the object, yet another embodiment of the present invention provides a method of manufacturing an ultra-thin glass to which a foldable transparent composite film is bonded

The method of manufacturing the ultra-thin glass (UTG) to which the foldable transparent composite film according to one embodiment of the present invention is bonded may further include forming the ultra-thin glass layer (210) on outer surfaces of one or more portions of the plastic resin layer (130) after the forming of the plastic resin layer (130).

In addition, according to one embodiment of the present invention, the method of manufacturing the ultra-thin glass to which the foldable transparent composite film is bonded may include forming the ultra-thin glass (210) on all of the folding part (1000) and the non-folding part (2000) of the transparent composite film, forming the glass-fabric layer in the non-folding layer with the empty folding part on one or more among above and under the ultra-thin glass layer (210) formed in the non-folding part (2000), and entirely coating plastic resin on the ultra-thin glass in the folding part and on the glass-fabric layer in the non-folding part, and entirely covering a plastic film and performing pressing and curing.

In addition, according to one embodiment of the present invention, the method of manufacturing the ultra-thin glass to which the foldable transparent composite film is bonded may include bonding the pre-manufactured transparent glass-fabric reinforced plastic film directly to the UTG using the optically clear adhesive (OCA).

According to the embodiments of the present invention, since the non-folding part (2000) of the plastic film used as the cover window for a foldable display is reinforced with the transparent glass-fabric reinforced plastic film with a high strength and elastic modulus and the foldability of the folding part (1000) is not degraded with the flexible plastic resin layer, it is possible to improve the pen-drop impact resistance of the non-folding part (2000) of the plastic film cover window and at the same time, implement the folding part (1000) with the excellent foldability.

In addition, according to one embodiment of the present invention, since, by being used as the protective film of the ultra-thin glass used as the cover window for a foldable display, the non-folding part (2000) of the ultra-thin glass can have the impact resistance reinforced with the plastic film and the glass-fabric reinforced plastic film and reduce the degradation in the foldability of the folding part (1000) due to the use of the protective film, it is possible to improve the pen-drop impact resistance of the non-folding part (2000) of the ultra-thin glass cover window and at the same time, implement the folding part (1000) with the excellent foldability.

It should be understood that the effects of the present invention are not limited to the above-described effects and include all effects inferable from the configuration of the invention described in the detailed description or claims of the present invention.

The above description of the present invention is for illustrative purpose, and those skilled in the art to which the present invention pertains will be able to understand that the present invention may be easily modified in other specific forms without changing the technical spirit or essential features thereof. Therefore, it should be understood that the above-described embodiments are illustrative and not restrictive in all respects.

### BRIEF DESCRIPTION OF THE DRAWINGS

FIG. 1 is a schematic diagram schematically illustrating a cross section of a foldable transparent composite film in which an area is divided into a folding part (1000) and a non-folding part (2000), a plastic film layer (110) and a plastic resin layer (130) are positioned in all of the folding part 1000 and the non-folding part (2000), and a transparent glass-fabric reinforced plastic (GFRP) film layer (120) is positioned in the non-folding part (2000).

FIG. 2 is a schematic diagram schematically illustrating a cross section of a foldable transparent composite cover window for a frontal foldable display in which the foldable transparent composite film (100) is attached to an ultra-thin glass (UTG) layer (210) as a protective film.

FIG. 3 is a schematic diagram schematically illustrating a cross section of the foldable transparent composite film (100) folded to allow the plastic resin layer (130) to be positioned externally and the plastic film layer (110) to be positioned internally.

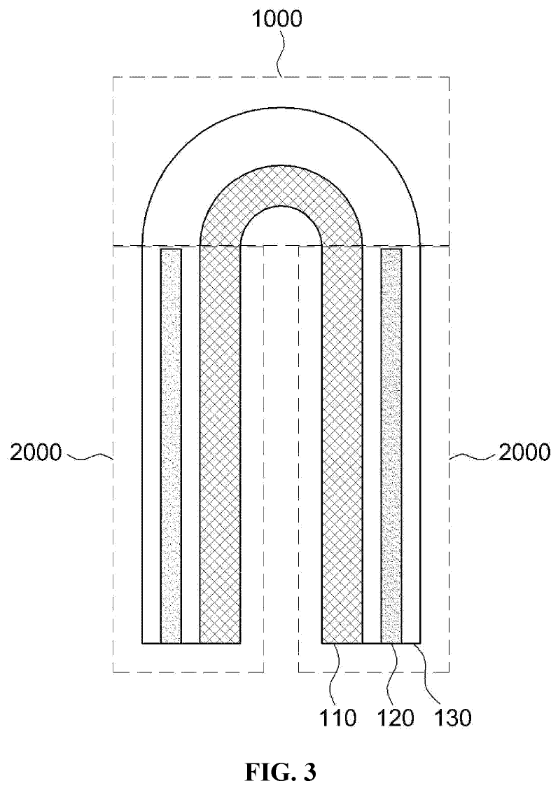

FIG. 4 is a schematic diagram schematically illustrating a cross section of the foldable transparent composite film (100) folded to allow the plastic resin layer (110) to be positioned externally and the plastic resin layer (130) to be positioned internally.

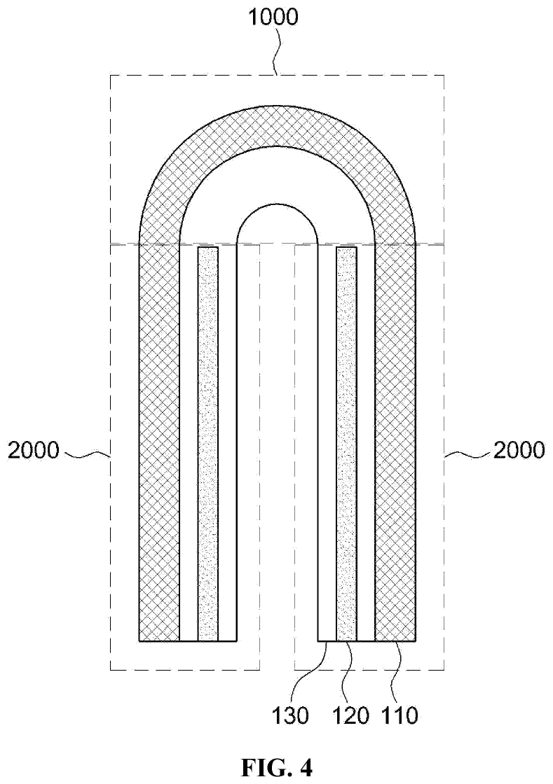

### DETAILED DESCRIPTION OF THE INVENTION

Hereinafter, the present invention will be described with reference to the accompanying drawings. However, the present invention may be implemented in various different forms and is not limited to embodiments described herein. In addition, in order to clearly describe the present invention in the drawings, components irrelevant to the description have been omitted, and throughout the specification, similar components have been denoted by similar reference numerals.

Throughout the specification, when a first component is described as being “connected to (joined to, in contact with, or coupled to)” a second component, this includes not only a case in which the first component is “directly connected” to the second component, but also a case in which the first component is “indirectly connected” to the second component with a third component interposed therebetween. In addition, when the first component is described as “including,” the second component, this means that the first component may further include the third component rather than precluding the third component unless especially stated otherwise.

The terms used in the specification are only used to describe specific embodiments and are not intended to limit the present invention. The singular expression includes the plural expression unless the context clearly dictates otherwise. In the specification, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Hereinafter, embodiments of the present invention will be described in detail with reference to the accompanying drawings.

A foldable transparent composite film (100) according to one embodiment of the present invention will be described.

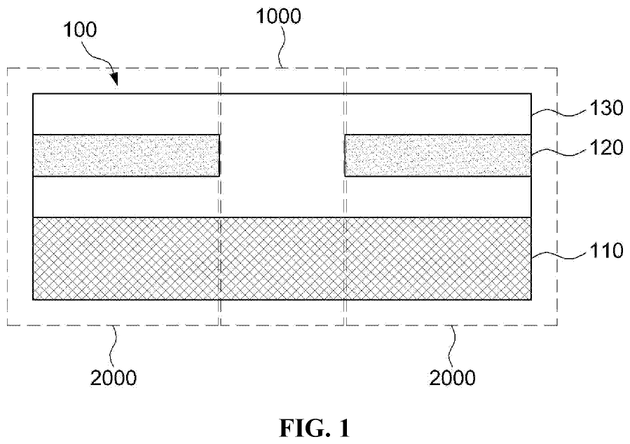

FIG. 1 is a schematic diagram schematically illustrating a cross section of a foldable transparent composite film in which an area is divided into a reinforced area and a flexible area on a plastic film, a transparent glass-fabric reinforced plastic (GFRP) film layer is positioned to the reinforced area, and a plastic resin coating layer is positioned in the flexible area according to one embodiment of the present invention.

Referring to FIG. 1, the foldable transparent composite film (100) according to one embodiment of the present invention includes a folding part 1000 and a non-folding part 2000 adjacent to the folding part and includes a transparent glass-fabric reinforced plastic film layer (120) in the non-folding part (2000).

As an example of the embodiment, the folding part (1000) may include a plastic film layer (110), and a plastic resin layer (130) positioned at one or more among above and under the plastic film layer 110.

In addition, according to one embodiment of the present invention, the non-folding part (2000) may include a plastic film layer (110) and a plastic resin layer (130) positioned on one or more among above and under the plastic film layer (110), wherein the transparent glass-fabric reinforced plastic film layer (120) may be buried in the plastic resin layer (130).

As an example of the embodiment, the plastic film layer 110 may include one selected from the group consisting of transparent polyimide (CPI), polyethylene terephthalate (PET), polyethylene naphthalate (PEN), polycarbonate (PC), acrylic, silicone, triacetyl cellulose (TAC), and combinations thereof.

In addition, according to one embodiment of the present invention, the transparent glass-fabric reinforced plastic film layer (120) may include a transparent plastic base and a glass-fabric buried in the transparent plastic base and a difference in refractive indexes between the transparent plastic and the glass-fabric may be 0.05 or less.

As an example of the embodiment, the transparent plastic base may include one selected from the group consisting of acrylic-based resin, epoxy-based resin, silicone-based resin, siloxane-based resin, styrene-based resin, styrene acrylonitrile-based resin, polycarbonate-based resin, polyester-based resin, polyurethane-based resin, acrylonitrile butadiene styrene-based resin, and combinations thereof.

As an example of the embodiment, the plastic film (110), the transparent glass-fabric reinforced plastic (GFRP) film (120), and the transparent plastic coating layer (130) may have a thickness of 0.1 mm or less which is a thickness in which each is foldable or bendable.

An ultra-thin glass (UTG) (200) to which the foldable transparent composite film according to one embodiment of the present invention is bonded will be described.

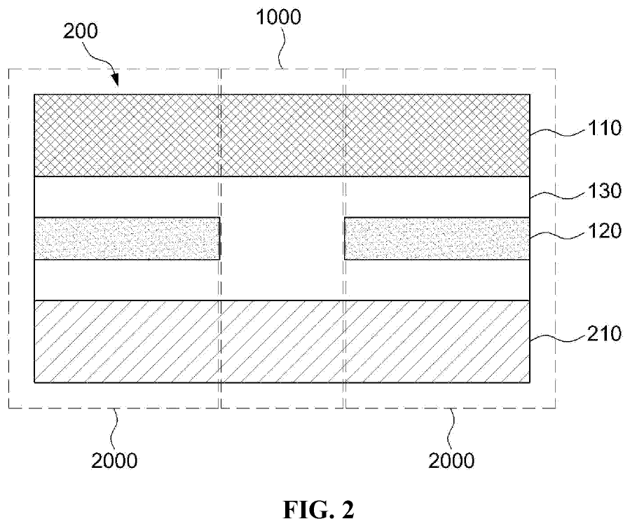

FIG. 2 is a schematic diagram schematically illustrating a cross section of a foldable transparent composite cover window for a frontal foldable display in which the foldable transparent composite film (100) is attached to an ultra-thin glass (UTG) layer (210) as a protective film.

Referring to FIG. 2, the ultra-thin glass (UTG) (200) to which the foldable transparent composite film according to one embodiment of the present invention is bonded may further include an UTG layer (210) above the plastic resin layer (130) in the above-described foldable transparent composite film.

The UTG (200) to which the foldable transparent composite film is bonded may further include the UTG layer (210) on outer surfaces of one or more portions of the plastic resin layer (130) in the above-described foldable transparent composite film.

Generally, when a substrate is folded, compression is applied to an inner surface of a folded part and tension is applied to an outer surface of the folded part, and when the folding is large (a folding radius decreases) and tensile strain of a predetermined level or more at which the substrate cannot withstand, the substrate is broken. In this case, the tensile strain due to folding becomes large in proportion to a degree of the folding and becomes large in inverse proportion to an elastic modulus and the cube of thickness of the substrate.

Therefore, a hard plastic film with a high elastic modulus of the substrate is not easily folded or bent, and cracks occur due to the large tensile strain occurring on the outer surface of the folded part upon folding, resulting in the breakage of the plastic film. In addition, a plastic film formed of a thick substrate is not easily folded or bent neither, and cracks occur due to the tensile strain occurring on the outer surface of the folded part upon folding, resulting in the breakage of the plastic film.

Therefore, a plastic film with excellent foldability, which is easily folded or bent, should include a substrate with a low elastic modulus and a small thickness. However, when a transparent plastic film is applied as a cover window for a foldable display, the plastic film requires strength, impact resistance, and surface wear resistance of the substrate to protect the display.

In order to improve the impact resistance of the plastic film, it is necessary to use a substrate with a high elastic modulus, which reduces the elastic strain of the plastic film due to an external impact, or use a thick plastic film which reduces the conveying of the elastic strain due to the external impact. However, since the plastic film with the high elastic modulus or the large thickness has degraded foldability, its application as the cover window for a foldable display is limited.

Therefore, in order to increase foldability while having the strength and impact resistance of the cover window for a foldable display, a method of dividing an area into a non-folding part, which uses a substrate with a high elastic modulus, and a folding part, which uses a substrate with a low elastic modulus, may be used.

However, since the plastic film is consecutively manufactured by using an injection or casting method, it is difficult to manufacture films with partially different elastic moduli. There is another method of varying an elastic modulus of hard coating applied on the plastic film, but this is not easy neither in terms of a process and may not increase a difference in elastic modulus.

In the present invention, in order to partially increase the clastic modulus of the plastic film used as the cover window for a foldable display, the reinforced area is formed by attaching the transparent glass-fabric reinforced plastic film with the high strength and elastic modulus.

In addition, the flexible area with a relatively low strength and elastic modulus is formed by coating the remaining areas with plastic resin. Therefore, the reinforced area in which the transparent glass-fabric reinforced plastic film is attached on the plastic film is used as the non-folding part, and the flexible area coated with the plastic resin is used as the folding part.

The foldable transparent composite film can be applied as the cover window for a foldable display capable of achieving impact resistance and foldability at the same time because the non-folding part (2000) has excellent impact resistance with the high strength and elastic modulus, while the folding part 1000 has excellent foldability with the low clastic modulus.

The plastic film (110) of the present invention may generally include one selected from the group

consisting of transparent polyimide (CPI), aramid, polyethylene terephthalate (PET), polyethylene naphthalate (PEN), polycarbonate (PC), acrylic-based, silicone-based, and triacetyl cellulose (TAC) films, and combinations thereof.

The present invention is not limited thereto, and any known film that can be used as a transparent plastic film can be used without limitation.

As the cover window for a foldable display, transparent polyimide (CPI) and aramid film, which have a high elastic modulus and excellent thermal resistance and durability, or polyethylene terephthalate (PET), which is inexpensive and has excellent optical characteristics, are preferred.

The transparent glass-fabric reinforced plastic film (120) of the present invention is a film in which a glass-fabric is buried inside a transparent plastic base and is a composite film with a high strength and clastic modulus as compared to general plastic films by reinforcing the inside of the plastic film with the glass-fabric as described above. The transparent glass-fabric reinforced plastic film 120 may be manufactured through a process of impregnating the glass-fabric with transparent plastic resin and performing pressing and curing.

When this transparent glass-fabric reinforced plastic film (120) is attached to the plastic film (110),

the clastic modulus of the overall transparent composite film can be increased to reduce elastic strain when an impact is applied to the film, and impact resistance can be improved due to the impact absorption of the glass-fabric therein.

In this case, a difference in refractive indexes between the glass-fabric and the transparent plastic may be 0.05 or less.

In general, glass-fabric reinforced plastic films in which a glass-fabric is buried in a transparent plastic film as a filler are not transparent. Therefore, the transparent glass-fabric reinforced plastic film of the present invention is made of a plastic resin which has a refractive index which is the same as or similar to the refractive index of the glass-fabric, and more specifically, in which a difference in refractive indexes between the glass-fabric and the transparent plastic base is 0.05 or less, and by minimizing a difference in optical characteristics between the glass-fabric and the transparent plastic base, the transparent glass-fabric reinforced plastic film manufactured as described above is transparent by preventing light scattering in the glass-fabric in the film.

When the difference in refractive indexes between the glass-fabric and the transparent plastic base exceeds 0.05, it is possible to reduce light transmittance, thereby making a pattern of the glass-fabric visible, which is not preferable. Therefore, as in the present invention, it is preferable to make the pattern of the glass-fabric invisible to achieve transparency by eliminating the difference in refractive indexes between the glass-fabric and the transparent resin plastic base.

The plastic resin used in the transparent glass-fabric reinforced plastic film 120 may include siloxane resin, silicone resin, acrylic-based resin, epoxy-based resin, styrene-based resin, styrene-acrylonitrile (SAN)-based resin, polycarbonate (PC)-based resin, polyester (PE)-based resin, polyurethane (PU)-based resin, acrylonitrile butadiene styrene (ABS)-based resin, and combinations thereof, but is not limited thereto, and any known resin that can be used as a transparent plastic film material can be used without limitation.

The transparent glass-fabric reinforced plastic film 120 of the present invention having the above-described configuration may have an optical transmittance of 80% or more.

The transparent plastic resin layer 130 of the present invention is a layer coated with the plastic resin which is the same one used in manufacturing the transparent glass-fabric reinforced plastic film and is a resin layer with a lower elastic modulus than the reinforced part to which the glass-fabric reinforced plastic film is attached.

Since the plastic resin used in the transparent glass-fabric reinforced plastic film attached to the reinforced part of the foldable transparent composite film and the plastic resin applied to the flexible part are the same, there is an advantage in that a sense of unity between the reinforced part and the flexible part can be created and during the process of attaching the glass-fabric reinforced plastic film, the reinforced part and the flexible part can be manufactured at the same time.

The foldable transparent composite film manufactured with the above configuration may have excellent impact resistance and foldability at the same time using the reinforce area to which the transparent glass-fabric reinforced plastic film is attached as the non-folding part and using the flexible area in which the plastic resin layer is positioned as the folding part.

The foldable transparent composite film may be formed so that a surface of the plastic film or surfaces of the glass-fabric reinforced plastic film and the plastic resin coating layer becomes an outer surface of the cover window for a foldable display, but in order to increase visibility and reduce pen-drop marks, it is advantageous to use the surface of the plastic film as the outer surface. In addition, it is possible to increase scratch resistance by adding a hard coating layer to the outer surface of the cover window for a foldable display.

In addition, the foldable transparent composite film may be provided as a protective film of an UTG cover window for a foldable display. In order to compensate for the low impact resistance of the UTG cover window, which is easily broken due to a small thickness, the protective film is used by being attached.

In this case, the protective film is mainly a polyethylene terephthalate (PET) film, which is inexpensive and has excellent optical characteristics. The protective film also requires the use of a film with a high elastic modulus or thick film to improve impact resistance but has a problem that foldability can be degraded.

Therefore, when the foldable transparent composite film is used as the protective film of the UTG cover window, the reinforced area is used as the non-folding part to improve impact resistance, and the flexible area is used as the folding part to reduce the degradation in foldability due to the increase in thickness caused by the use of the protective film.

With the above structural characteristics, according to one embodiment of the present invention, the non-folding part of the plastic film or UTG used as the cover window for a foldable display can have improved impact resistance by attaching the transparent glass-fabric reinforced plastic film with the high elastic modulus, and the folding part may have excellent foldability using the plastic resin layer with the low elastic modulus.

A foldable display device according to another embodiment of the present invention will be described.

The foldable display device of the present invention may include the foldable transparent composite film according to one embodiment of the present invention.

The foldable transparent composite film may be used as the cover window for a foldable display or the protective film of the cover window.

The foldable display device of the present invention may include the foldable transparent composite film according to one embodiment of the present invention, which is disposed on a film including a cover window, a touch circuit, and a display circuit when applied to the foldable display device, but is not limited thereto.

Due to the above structural characteristics, according to one embodiment of the present invention, the foldable transparent composite film can be used as the cover window and the cover window protective film of the foldable display to improve impact resistance and foldability, and the cover window can be formed on a front surface of the display to protect a display panel and used as a touch screen.

A method of manufacturing the foldable transparent composite film according to still another embodiment of the present invention will be described.

As an example of the embodiment, the method of manufacturing the foldable transparent composite film includes forming the plastic film layer (110) on all of the folding part 1000 and the non-folding part (2000), and forming the plastic resin layer 130 positioned on one or more among above and under the formed plastic film layer (110), in which the transparent glass-fabric reinforced plastic film layer (120) is buried in the non-folding part (2000) of the formed plastic resin layer (130).

As an example of the embodiment, the forming of the plastic resin layer (130) may include forming a glass-fabric layer in the non-folding part (2000) with an empty folding part on one or more among above and under the plastic film layer (110), and entirely coating plastic resin on the plastic film layer in the folding part and the glass-fabric layer in the non-folding part, and performing pressing and curing.

As an example of the embodiment, the plastic film layer 110 may include one selected from the group consisting of transparent polyimide (CPI), polyethylene terephthalate (PET), polyethylene naphthalate (PEN), polycarbonate (PC), acrylic, silicone, triacetyl cellulose (TAC), and combinations thereof.

As an example of the embodiment, the transparent glass-fabric reinforced plastic film layer 120 may include the transparent plastic base and the glass-fabric buried in the transparent plastic base, and a difference in refractive indexes between the transparent plastic and the glass-fabric may be 0.05 or less.

As an example of the embodiment, the transparent plastic base may include one selected from the group consisting of acrylic-based resin, epoxy-based resin, silicone-based resin, siloxane-based resin, styrene-based resin, styrene acrylonitrile-based resin, polycarbonate-based resin, polyester-based resin, polyurethane-based resin, acrylonitrile butadiene styrene-based resin, and combinations thereof.

A method of manufacturing the UTG to which the foldable transparent composite film according to one embodiment of the present invention is bonded will be described.

The method of manufacturing the ultra-thin glass (UTG) to which the foldable transparent composite film according to one embodiment of the present invention is bonded may further include forming the ultra-thin glass layer (210) on outer surfaces of one or more portions of the plastic resin layer (130) after the forming of the plastic resin layer (130).

As an example of the embodiment, the method of manufacturing the UTG to which the foldable transparent composite film is bonded may include forming the ultra-thin glass (210) on all of the folding part (1000) and the non-folding part (2000) of the transparent composite film, forming the glass-fabric layer in the non-folding layer with the empty folding part on one or more among above and under the ultra-thin glass layer (210) formed in the non-folding part (2000), and entirely coating plastic resin on the ultra-thin glass in the folding part and on the glass-fabric layer in the non-folding part, and entirely covering a plastic film and performing pressing and curing.

In the forming of the glass-fabric layer with the empty folding part, a glass-fabric pre-preg impregnating with the plastic resin in advance can be used.

In addition, in the forming of the glass-fabric layer with the empty folding part, in order to avoid the use of an adhesive with a flexible property, the transparent glass-fabric reinforced plastic film layer 120 may be directly bonded by arranging the glass-fabric above the UTG layer, coating and then directly impregnating the glass-fabric with the transparent plastic resin thereabove, and performing pressing and curing.

As an example of the embodiment, the method of manufacturing the UTG to which the foldable transparent composite film is bonded may include bonding the pre-manufactured transparent glass-fabric reinforced plastic film directly to the UTG using the optically clear adhesive (OCA)

The foldable transparent composite film (100) or the UTG 200 to which the foldable transparent composite film is bonded, which is manufactured as described above, may have an advantage in that it is possible to easily perform the work dividing the area into the reinforced area of the non-folding part (2000) and the flexible area of the folding part (1000) using the coating and pressing process once.

With the above structural characteristics, according to one embodiment of the present invention, the plastic film layer is formed in all of the folding part (1000) and the non-folding part (2000), and by forming the flexible area as the folding part (1000) and forming the reinforced area as the non-folding part (2000), it is possible to achieve high impact resistance and excellent foldability.

Hereinafter, the present invention will be described in more detail through manufacturing examples, comparative examples, and experimental examples. However, the present invention is not limited to the manufacturing examples and experimental examples below.

### Manufacturing Example 1 Foldable Transparent Composite Film

A plastic film obtained by cutting a transparent PI film (CPI by Kolon Industry) with a thickness of 0.03 mm and a PET film (A4300 by Toyobo) with a thickness of 0.05 mm into an area of 150 mm×200 mm and a glass-fabric (1037 by Nittobo) with a thickness of 0.025 mm cut into an area of 150 mm×90 mm were provided. The glass-fabric was positioned at both ends of the provided plastic film so that an interval of 20 mm was formed in the middle of the plastic film. The foldable transparent composite film for a foldable display was manufactured by coating or impregnating the glass-fabric with transparent siloxane resin (ClearFRP by Solip Tech), positioning a release film thereabove, performing roll lamination or pressing and curing, and then removing the release film. Therefore, as illustrated in FIG. 1, the reinforced area in which the glass-fabric is positioned is formed as the non-folding part, and the flexible area between the non-folding part is formed as the folding part.

### Manufacturing Example 2 UTG to Which the Foldable Transparent Composite Protective Film is Bonded

An UTG with an area of 150 mm×200 mm and a thickness of 0.03 mm, a plastic film obtained by cutting a transparent PI film (CPI by Kolon Industry) with a thickness of 0.03 mm and a PET film (A4300 by Toyobo) with a thickness of 0.05 mm into an area of 150 mm×200 mm, and a glass-fabric (1037 by Nittobo) with a thickness of 0.025 mm cut into an area of 150 mm×90 mm were provided. The glass fabric was positioned at both ends of the provided UTG so that an interval of 20 mm was formed in the middle of the UTG. The UTG to which the foldable transparent composite film protective film for a foldable display was bonded was manufactured by coating or impregnating the glass-fabric with transparent siloxane resin (ClearFRP by Solip Tech), positioning the provided plastic film thereabove, performing roll lamination or pressing and curing, and directly bonding the foldable transparent composite film to the UTG as the protective film. As illustrated in FIG. 2, the reinforced area in which the glass-fabric is positioned is formed as the non-folding part, and the flexible area between the non-folding part is formed as the folding part.

### Comparative Manufacturing Example 1. Foldable Transparent Composite Film Without Area Division

A plastic film obtained by cutting a transparent PI film (CPI by Kolon Industry) with a thickness of 0.03 mm and a PET film (A4300 by Toyobo) with a thickness of 0.05 mm into an area of 150 mm×200 mm and a glass-fabric (1037 by Nittobo) with a thickness of 0.025 mm cut into an area of 150 mm×90 mm were provided. The foldable transparent composite film for a foldable display was manufactured by positioning the glass-fabric on the overall area above the provided plastic film, coating or impregnating the glass-fabric with transparent siloxane resin (ClearFRP by Solip Tech), positioning a release film thereabove, performing roll lamination or pressing and curing, and then removing the release film.

### Comparative Manufacturing Example 2. UTG to Which the Foldable Transparent Composite Film Without Area Division is Bonded

An ultra-thin glass with an area of 150 mm×200 mm and a thickness of 0.03 mm, a plastic film obtained by cutting a transparent PI film (CPI by Kolon Industry) with a thickness of 0.03 mm and a PET film (A4300 by Toyobo) with a thickness of 0.05 mm into an area of 150 mm×200 mm, and a glass-fabric (1037 by Nittobo) with a thickness of 0.025 mm cut into an area of 150 mm×90 mm were provided. The UTG to which the foldable transparent composite film for a foldable display was bonded was manufactured by positioning the glass-fabric on the overall area above the provided UTG, coating or impregnating the glass-fabric with transparent siloxane resin (ClearFRP by Solip Tech), positioning the provided plastic film thereabove, performing roll lamination or pressing and curing, and directly bonding the foldable transparent composite film to the UTG as the protective film.

### Experimental Example 1. Folding Test

In order to evaluate the folding characteristics of the foldable transparent composite film and the UTG obtained in the manufacturing examples or comparative manufacturing examples, a stress-free U-shaped folding tester (YUASA System) was used to measure the folding radii of the foldable transparent composite film and the UTG, which withstand 100,000 foldings, and a result of the measurement is shown in Table 1 below. It shows that the smaller the folding radius, the better the folding characteristics.

### Experimental Example 2. Pen-Drop Test

In order to evaluate the pen-drop impact resistance properties of the non-folding reinforced area of the UTG obtained in Manufacturing Example 2 or Comparative Manufacturing Example 2, the UTG was bonded to a glass substrate using an adhesive (3M OCA 8146-1) with a thickness of 0.025 mm and then a commercial ballpoint pen (BIC Crystal Fine 0.7 mm) was dropped at a predetermined height to measure the maximum height at which the glass substrate was not broken, and a result of the measurement is shown in Table 1 below.

TABLE 1

| | | | | | Comparative | | Comparative | |
|---|---|---|---|---|---|---|---|---|
| | Manufacturing | | Manufacturing | | Manufacturing | | Manufacturing | |
| | Example 1 | | Example 2 | | Example 1 | | Example 2 | |
| Plastic film | CPI | PET | CPI | PET | CPI | PET | CPI | PET |
| Thickness (mm) | 0.03 | 0.05 | 0.03 | 0.05 | 0.03 | 0.05 | 0.03 | 0.05 |
| of plastic film | | | | | | | | |
| Thickness (mm) | | | 0.03 | 0.03 | | | 0.03 | 0.03 |
| of ultra-thin | | | | | | | | |
| glass (UTG) | | | | | | | | |
| Folding radius | 1.5 | 1.5 | 3.0 | 4.0 | 2.5 | 3.0 | 4.0 | 5.0 |
| (mm) of GFRP | | | | | | | | |
| film/inner | | | | | | | | |
| side of UTG | | | | | | | | |
| Folding radius | 2.0 | 2.5 | 3.5 | 4.5 | 3.5 | 4.0 | 5.5 | 6.5 |
| (mm) of inner | | | | | | | | |
| side of plastic | | | | | | | | |
| film | | | | | | | | |
| Pen-drop impact | | | 30 | 30 | | | 30 | 30 |
| resistance | | | | | | | | |
| height (cm) of | | | | | | | | |
| reinforced area | | | | | | | | |

As can be seen in Table 1, the folding radius is smaller when using the CPI film with a thickness of 0.03 mm than when using the PET film with a thickness of 0.05 mm in the foldable transparent composite film and the UTG in the manufacturing examples and comparative manufacturing examples. Therefore, since the tension at the outer surface of the folded part generated by folding is proportional to the cube of the thickness of the base, it is advantageous to use the plastic film with a small thickness. In addition, the foldable transparent composite film and UTG in which the area is divided into the reinforced area and the flexible area in the embodiment have much smaller folding radii than the foldable transparent composite film and UTG without area division in the comparative examples. This means that the folding radii in the embodiment in which the flexible area with the low elastic modulus is folded is smaller than the folding radii in the comparative examples in which the reinforced area with the high elastic modulus is folded. Since the tension at the outer side of the folded part generated by folding is proportional to the elastic modulus of the base, the folding in the embodiment in which the flexible area with the low elastic modulus is folded is more advantageous than the folding in the comparative examples. On the other hand, the pen-drop impact resistance characteristics of the UTG are similar for all samples using the CPI film with a thickness of 0.03 mm or the PET film with a thickness of 0.05 mm as the plastic film in the embodiment and the comparative examples. This is because the UTG has the similar pen-drop impact resistance characteristics regardless of the use of the thin CPI film and the thick PET film because the UTG is protected by the same foldable transparent composite film and the thin PET film has a higher elastic modulus than the thick CPI film.

According to the embodiments of the present invention, since the non-folding part 2000 of the plastic film used as the cover window for a foldable display is reinforced with the transparent glass-fabric reinforced plastic film with a high strength and elastic modulus and the foldability of the folding part (1000) is not degraded with the flexible plastic coating layer, it is possible to improve the pen-drop impact resistance of the non-folding part (2000) of the plastic film cover window and at the same time, implement the folding part (1000) with the excellent foldability.

In addition, according to one embodiment of the present invention, since, by being used as the protective film of the ultra-thin glass used as the cover window for a foldable display, the non-folding part (2000) of the ultra-thin glass can have the impact resistance reinforced with the plastic film and the glass-fabric reinforced plastic film and reduce the degradation in the foldability of the folding part (1000) due to the use of the protective film, it is possible to improve the pen-drop impact resistance of the non-folding part (2000) of the ultra-thin glass cover window and at the same time, implement the folding part (1000) with the excellent foldability.

It should be understood that the effects of the present invention are not limited to the above-described effects and include all effects inferable from the configuration of the invention described in the detailed description or claims of the present invention.

The above description of the present invention is for illustrative purpose, and those skilled in the art to which the present invention pertains will be able to understand that the present invention may be easily modified in other specific forms without changing the technical spirit or essential features thereof. Therefore, it should be understood that the above-described embodiments are illustrative and not restrictive in all respects. For example, each component described in a singular form may be implemented separately, and likewise, components described as being implemented separately may also be implemented in a combined form.

The scope of the present invention is defined by the claims to be described below, and all changes or modifications derived from the meaning and scope of the claims and equivalent concepts thereof should be construed as being included in the scope of the present invention.

### DESCRIPTION OF REFERENCE NUMERALS

1000: folding part
2000: non-folding part
100: foldable transparent composite film
110: plastic film layer
120: transparent glass-fabric reinforced plastic film layer
130: plastic resin layer
200: ultra-thin glass to which foldable transparent composite protective film is bonded
210: ultra-thin glass layer

1. A foldable transparent composite film comprising:
a folding part; and
a non-folding part adjacent to the folding part,
wherein the non-folding part includes a transparent glass-fabric reinforced plastic film layer.

2. The foldable transparent composite film of claim 1, wherein the folding part includes:
a plastic film layer; and
a plastic resin layer positioned on at least one surface of the plastic film layer.

3. The foldable transparent composite film of claim 1, wherein the non-folding part includes:
a plastic film layer; and
a plastic resin layer positioned on at least one surface of the plastic film layer,
wherein the transparent glass-fabric reinforced plastic film layer is buried in the plastic resin layer.

4. The foldable transparent composite film of claim 2, wherein the plastic resin layer includes at least one selected from a group consisting of transparent polyimide (CPI), polyethylene terephthalate (PET), polyethylene naphthalate (PEN), polycarbonate (PC), acrylic, silicone, triacetyl cellulose (TAC), and combinations thereof.

5. The foldable transparent composite film of claim 1, wherein the transparent glass-fabric reinforced plastic film layer includes:
a transparent plastic base; and
a glass-fabric buried in the transparent plastic base,
wherein a difference in refractive indexes between the transparent plastic base and the glass-fabric is 0.05 or less.

6. The foldable transparent composite film of claim 5, wherein the transparent plastic base includes at least one selected from a group consisting of acrylic-based resin, epoxy-based resin, silicone-based resin, siloxane-based resin, styrene-based resin, styrene acrylonitrile-based resin, polycarbonate-based resin, polyester-based resin, polyurethane-based resin, acrylonitrile butadiene styrene-based resin, and combinations thereof.

7. The foldable transparent composite film of claim 2, further comprising an ultra-thin glass layer adjacent to a surface opposite to a surface adjacent to the plastic film layer of both surfaces of the plastic resin layer.

8. A method of manufacturing a foldable transparent composite film, comprising:
providing a plastic film layer; and
forming a plastic resin layer positioned on at least one surface of the plastic film layer,
wherein the foldable transparent composite film has a folding part and a non-folding part adjacent to the folding part, and a transparent glass-fabric reinforced plastic film layer is buried in the plastic resin layer positioned in the non-folding part.

9. The method of claim 8, wherein the forming of the plastic resin layer includes:
forming a glass-fabric layer with an empty folding part by forming the glass-fabric layer on at least one surface of the plastic film layer formed in the non-folding part; and
entirely coating a surface opposite to a surface adjacent to the plastic film layer of both surfaces of the glass-fabric layer with the empty folding part with plastic resin and performing compressing and curing.

10. The method of claim 9, wherein the glass-fabric layer includes a glass-fabric pre-preg impregnating with the plastic resin in advance.

11. The method of claim 8, further comprising forming an ultra-thin glass layer on a surface opposite to a surface adjacent to the plastic film layer of both surfaces of the plastic resin layer after the forming of the plastic resin layer.

12. The method of claim 8, further comprising forming an ultra-thin glass layer bonded by an optically clear adhesive on a surface opposite to a surface adjacent to the plastic film layer of both surfaces of the plastic resin layer.

13. A foldable display device comprising:
the foldable transparent composite film of claim 1 as a cover window or a protective film of the an ultra-thin glass cover window.

14. The foldable transparent composite film of claim 3, wherein the plastic resin layer includes at least one selected from a group consisting of transparent polyimide (CPI), polyethylene terephthalate (PET), polyethylene naphthalate (PEN), polycarbonate (PC), acrylic, silicone, triacetyl cellulose (TAC), and combinations thereof.

15. The foldable transparent composite film of claim 3, further comprising an ultra-thin glass layer adjacent to a surface opposite to a surface adjacent to the plastic film layer of both surfaces of the plastic resin layer.
